SEQUENCE LISTING (95 sequences)

SEQ ID NO: 1 - DNA, 31 bp, Artificial Sequence
  Description of Artificial Sequence Synthetic oligonucleotide
ccaggttcacgccattctcctcccagcctcc

SEQ ID NO: 2 - DNA, 18 bp, Artificial Sequence
  Description of Artificial Sequence Synthetic oligonucleotide
tagatgggcctggttttt

SEQ ID NO: 3 - DNA, 18 bp, Artificial Sequence
  Description of Artificial Sequence Synthetic oligonucleotide
cgcagaagacaacatgcg

SEQ ID NO: 4 - DNA, 15 bp, Artificial Sequence
  Description of Artificial Sequence Synthetic oligonucleotide
cacccagcctccaag

SEQ ID NO: 5 - DNA, 26 bp, Artificial Sequence
  Description of Artificial Sequence Synthetic oligonucleotide
tcaggagcttatttcaagccaaggaa

SEQ ID NO: 6 - DNA, 20 bp, Artificial Sequence
  Description of Artificial Sequence Synthetic oligonucleotide
gtgccctgagccgcctgagg

SEQ ID NO: 7 - DNA, 21 bp, Artificial Sequence
  Description of Artificial Sequence Synthetic oligonucleotide
catcctcaccatcatcacact

SEQ ID NO: 8 - DNA, 19 bp, Artificial Sequence
  Description of Artificial Sequence Synthetic oligonucleotide
cgctgggactgggcaaccg

SEQ ID NO: 9 - DNA, 18 bp, Artificial Sequence
  Description of Artificial Sequence Synthetic oligonucleotide
agagtgcgggattgtagg

SEQ ID NO: 10 - DNA, 23 bp, Artificial Sequence
  Description of Artificial Sequence Synthetic oligonucleotide
gggatattcaactttggcagagt

SEQ ID NO: 11 - DNA, 34 bp, Artificial Sequence
  Description of Artificial Sequence Synthetic oligonucleotide
ccaatggatcactcacagtttccataggtctgaa

SEQ ID NO: 12 - DNA, 15 bp, Artificial Sequence
  Description of Artificial Sequence Synthetic oligonucleotide
acccatctacagctt

SEQ ID NO: 13 - DNA, 36 bp, Artificial Sequence
  Description of Artificial Sequence Synthetic oligonucleotide
cttgtcctttctggagcctagtccagctccaggtag

SEQ ID NO: 14 - DNA, 29 bp, Artificial Sequence
  Description of Artificial Sequence Synthetic oligonucleotide
aagcaggagcagaggataggatgcaaggg

SEQ ID NO: 15 - DNA, 28 bp, Artificial Sequence
  Description of Artificial Sequence Synthetic oligonucleotide
agaggcagcctcccctgcttgcgggcgc

SEQ ID NO: 16 - DNA, 25 bp, Artificial Sequence
  Description of Artificial Sequence Synthetic oligonucleotide
accaccagtgcctggtaattttttg

SEQ ID NO: 17 - DNA, 34 bp, Artificial Sequence
  Description of Artificial Sequence Synthetic oligonucleotide
ctttctggagctaagctccagctccagtagctgg

SEQ ID NO: 18 - DNA, 30 bp, Artificial Sequence
  Description of Artificial Sequence Synthetic oligonucleotide
gcagagactgtgggaagcgaaaattccatg

SEQ ID NO: 19 - DNA, 29 bp, Artificial Sequence
  Description of Artificial Sequence Synthetic oligonucleotide
ctctgactgtaccaccatcacacaactac

SEQ ID NO: 20 - DNA, 13 bp, Artificial Sequence
  Description of Artificial Sequence Synthetic oligonucleotide
ccaggttcacgcc

SEQ ID NO: 21 - DNA, 13 bp, Artificial Sequence
  Description of Artificial Sequence Synthetic oligonucleotide
caggttcacgcca

SEQ ID NO: 22 - DNA, 13 bp, Artificial Sequence
  Description of Artificial Sequence Synthetic oligonucleotide
aggttcacgccat

SEQ ID NO: 23 - DNA, 13 bp, Artificial Sequence
  Description of Artificial Sequence Synthetic oligonucleotide
ggttcacgccatt

SEQ ID NO: 24 - DNA, 13 bp, Artificial Sequence
  Description of Artificial Sequence Synthetic oligonucleotide
gttcacgccattc

SEQ ID NO: 25 - DNA, 13 bp, Artificial Sequence
  Description of Artificial Sequence Synthetic oligonucleotide
ttcacgccattct

SEQ ID NO: 26 - DNA, 14 bp, Artificial Sequence
  Description of Artificial Sequence Synthetic oligonucleotide
ccaggttcacgcca

SEQ ID NO: 27 - DNA, 14 bp, Artificial Sequence
  Description of Artificial Sequence Synthetic oligonucleotide
caggttcacgccat

SEQ ID NO: 28 - DNA, 14 bp, Artificial Sequence
  Description of Artificial Sequence Synthetic oligonucleotide
aggttcacgccatt

SEQ ID NO: 29 - DNA, 14 bp, Artificial Sequence
  Description of Artificial Sequence Synthetic oligonucleotide
ggttcacgccattc

SEQ ID NO: 30 - DNA, 14 bp, Artificial Sequence
  Description of Artificial Sequence Synthetic oligonucleotide
gttcacgccattct

SEQ ID NO: 31 - DNA, 30 bp, Artificial Sequence
  Description of Artificial Sequence Synthetic oligonucleotide
ccaggttcacgccattctcctcccagcctc

SEQ ID NO: 32 - DNA, 30 bp, Artificial Sequence
  Description of Artificial Sequence Synthetic oligonucleotide
caggttcacgccattctcctcccagcctcc

SEQ ID NO: 33 - DNA, 19 bp, Artificial Sequence
  Description of Artificial Sequence Synthetic oligonucleotide
ccctcccccaacaccatgc

SEQ ID NO: 34 - DNA, 14 bp, Artificial Sequence
  Description of Artificial Sequence Synthetic oligonucleotide
ggtttcaccgttag

SEQ ID NO: 35 - DNA, 13 bp, Artificial Sequence
  Description of Artificial Sequence Synthetic oligonucleotide
acctaccagggca

SEQ ID NO: 36 - DNA, 22 bp, Artificial Sequence
  Description of Artificial Sequence Synthetic oligonucleotide
aggcattgaagtctcatggaag

SEQ ID NO: 37 - DNA, 16 bp, Artificial Sequence
  Description of Artificial Sequence Synthetic oligonucleotide
tccaaacaaaagaaat

SEQ ID NO: 38 - DNA, 13 bp, Artificial Sequence
  Description of Artificial Sequence Synthetic oligonucleotide
ctcagtgatcttc

SEQ ID NO: 39 - DNA, 20 bp, Artificial Sequence
  Description of Artificial Sequence Synthetic oligonucleotide
gacggaacagctttgaggtg

SEQ ID NO: 40 - DNA, 13 bp, Artificial Sequence
  Description of Artificial Sequence Synthetic oligonucleotide
agaatgctgaggg

SEQ ID NO: 41 - DNA, 20 bp, Artificial Sequence
  Description of Artificial Sequence Synthetic oligonucleotide
ggcagtgacccggaaggcag

SEQ ID NO: 42 - DNA, 16 bp, Artificial Sequence
  Description of Artificial Sequence Synthetic oligonucleotide
aggaaagaggcaagga

SEQ ID NO: 43 - DNA, 22 bp, Artificial Sequence
  Description of Artificial Sequence Synthetic oligonucleotide
tcatcacactggaagactccag

SEQ ID NO: 44 - DNA, 18 bp, Artificial Sequence
  Description of Artificial Sequence Synthetic oligonucleotide
ctcccttatcttgcatcc

SEQ ID NO: 45 - DNA, 17 bp, Artificial Sequence
  Description of Artificial Sequence Synthetic oligonucleotide
gcggcccctgcacagcc

SEQ ID NO: 46 - DNA, 14 bp, Artificial Sequence
  Description of Artificial Sequence Synthetic oligonucleotide
agtaggaaatcagg

SEQ ID NO: 47 - DNA, 18 bp, Artificial Sequence
  Description of Artificial Sequence Synthetic oligonucleotide
cactggaagacggcagca

SEQ ID NO: 48 - DNA, 30 bp, Artificial Sequence
  Description of Artificial Sequence Synthetic oligonucleotide
agttgggaatagggtgcacatttaggaagt

SEQ ID NO: 49 - DNA, 30 bp, Artificial Sequence
  Description of Artificial Sequence Synthetic oligonucleotide
ccgggtcactgccatggaggagccgcagtc

SEQ ID NO: 50 - DNA, 31 bp, Artificial Sequence
  Description of Artificial Sequence Synthetic oligonucleotide
ccgggtcactgccatggaggagccgcagtca

SEQ ID NO: 51 - DNA, 31 bp, Artificial Sequence
  Description of Artificial Sequence Synthetic oligonucleotide
ccgggtcactgccatggaggagccgcagtcc

SEQ ID NO: 52 - DNA, 31 bp, Artificial Sequence
  Description of Artificial Sequence Synthetic oligonucleotide
ccgggtcactgccatggaggagccgcagtct

SEQ ID NO: 53 - DNA, 31 bp, Artificial Sequence
  Description of Artificial Sequence Synthetic oligonucleotide
ccgggtcactgccatggaggagccgcagtcg

SEQ ID NO: 54 - DNA, 22 bp, Artificial Sequence
  Description of Artificial Sequence Synthetic oligonucleotide
tgccatggaggagccgcagtca

SEQ ID NO: 55 - DNA, 21 bp, Artificial Sequence
  Description of Artificial Sequence Synthetic oligonucleotide
gccatggaggagccgcagtca

SEQ ID NO: 56 - DNA, 19 bp, Artificial Sequence
  Description of Artificial Sequence Synthetic oligonucleotide
catggaggagccgcagtca

SEQ ID NO: 57 - DNA, 18 bp, Artificial Sequence
  Description of Artificial Sequence Synthetic oligonucleotide
atggaggagccgcagtca

SEQ ID NO: 58 - DNA, 17 bp, Artificial Sequence
  Description of Artificial Sequence Synthetic oligonucleotide
tggaggagccgcagtca

SEQ ID NO: 59 - DNA, 16 bp, Artificial Sequence
  Description of Artificial Sequence Synthetic oligonucleotide
ggaggagccgcagtca

SEQ ID NO: 60 - DNA, 15 bp, Artificial Sequence
  Description of Artificial Sequence Synthetic oligonucleotide
gaggagccgcagtca

SEQ ID NO: 61 - DNA, 14 bp, Artificial Sequence
  Description of Artificial Sequence Synthetic oligonucleotide
aggagccgcagtca

SEQ ID NO: 62 - DNA, 40 bp, Artificial Sequence
  Description of Artificial Sequence Synthetic oligonucleotide
ggttaagggtggttgtcagtggccctccgggtgagcagta

SEQ ID NO: 63 - DNA, 16 bp, Artificial Sequence
  Description of Artificial Sequence Synthetic oligonucleotide
tccaggtccccagccc

SEQ ID NO: 64 - DNA, 78 bp, Artificial Sequence
  Description of Artificial Sequence Synthetic oligonucleotide
ccccccagccccccagccctccaggtccccagcccaacccttgtccttaccngaacgttgttttcaggaagtctgaaa

SEQ ID NO: 65 - DNA, 37 bp, Artificial Sequence
  Description of Artificial Sequence Synthetic oligonucleotide
ccctccaggtccccagcccaaccctgtccttaccnga

SEQ ID NO: 66 - DNA, 36 bp, Artificial Sequence
  Description of Artificial Sequence Synthetic oligonucleotide
ccctccaggtccccagcccaaccctttccttaccng

SEQ ID NO: 67 - DNA, 36 bp, Artificial Sequence
  Description of Artificial Sequence Synthetic oligonucleotide
cctccaggtcccagcccaacccttgtccttaccnga

SEQ ID NO: 68 - DNA, 36 bp, Artificial Sequence
  Description of Artificial Sequence Synthetic oligonucleotide
ctccaggtcccagcccaacccttgtccttaccngaa

SEQ ID NO: 69 - DNA, 36 bp, Artificial Sequence
  Description of Artificial Sequence Synthetic oligonucleotide
ctccaggtccccagcccaacccttgtccttaccnga

SEQ ID NO: 70 - DNA, 35 bp, Artificial Sequence
  Description of Artificial Sequence Synthetic oligonucleotide
ctccaggtccccagcccaacccttgtccttacnga

SEQ ID NO: 71 - DNA, 35 bp, Artificial Sequence
  Description of Artificial Sequence Synthetic oligonucleotide
ctccaggtcccagcccaacccttgtccttaccnga

SEQ ID NO: 72 - DNA, 34 bp, Artificial Sequence
  Description of Artificial Sequence Synthetic oligonucleotide
ctccaggtccccagcccaaccttgtccttaccng

SEQ ID NO: 73 - DNA, 33 bp, Artificial Sequence
  Description of Artificial Sequence Synthetic oligonucleotide
ctccaggtccccagcccaacccttgtccttacn

SEQ ID NO: 74 - DNA, 34 bp, Artificial Sequence
  Description of Artificial Sequence Synthetic oligonucleotide
tccaggtccccagcccaacccttgtccttaccng

SEQ ID NO: 75 - DNA, 35 bp, Artificial Sequence
  Description of Artificial Sequence Synthetic oligonucleotide
ccaggtccccagcccaaccttgtccttaccngaac

SEQ ID NO: 76 - DNA, 36 bp, Artificial Sequence
  Description of Artificial Sequence Synthetic oligonucleotide
ccaggtccccagcccaacccttgtccttaccngaac

SEQ ID NO: 77 - DNA, 36 bp, Artificial Sequence; identical to SEQ ID NO: 76
  Description of Artificial Sequence Synthetic oligonucleotide

SEQ ID NO: 78 - DNA, 35 bp, Artificial Sequence
  Description of Artificial Sequence Synthetic oligonucleotide
cggtccccagcccaacccttgtccttaccngaacg

SEQ ID NO: 79 - DNA, 35 bp, Artificial Sequence
  Description of Artificial Sequence Synthetic oligonucleotide
caggtcccagcccaacccttgtccttaccngaacg

SEQ ID NO: 80 - DNA, 34 bp, Artificial Sequence
  Description of Artificial Sequence Synthetic oligonucleotide
caggtccccgcccaacccttgtccttaccngaac

SEQ ID NO: 81 - DNA, 34 bp, Artificial Sequence
  Description of Artificial Sequence Synthetic oligonucleotide
caggtccccagcccaaccttgtccttaccngaac

SEQ ID NO: 82 - DNA, 33 bp, Artificial Sequence
  Description of Artificial Sequence Synthetic oligonucleotide
caggtccccagccaacccttgtccttaccngaa

SEQ ID NO: 83 - DNA, 30 bp, Artificial Sequence
  Description of Artificial Sequence Synthetic oligonucleotide
caggtccccagccaacccttgtccttaccn

SEQ ID NO: 84 - DNA, 30 bp, Artificial Sequence
  Description of Artificial Sequence Synthetic oligonucleotide
caggtccccagcccaaccttgtccttaccn

SEQ ID NO: 85 - DNA, 35 bp, Artificial Sequence
  Description of Artificial Sequence Synthetic oligonucleotide
aggtccccagcccaacccttgtcttaccngaacgt

SEQ ID NO: 86 - DNA, 33 bp, Artificial Sequence
  Description of Artificial Sequence Synthetic oligonucleotide
aggtccccagcccaacccttgtccttaccngaa

SEQ ID NO: 87 - DNA, 33 bp, Artificial Sequence
  Description of Artificial Sequence Synthetic oligonucleotide
ggtccccagcccaaccttgtccttaccngaacg

SEQ ID NO: 88 - DNA, 33 bp, Artificial Sequence
  Description of Artificial Sequence Synthetic oligonucleotide
ggtccccagcccaacccttgtccttaccngaac

SEQ ID NO: 89 - DNA, 31 bp, Artificial Sequence
  Description of Artificial Sequence Synthetic oligonucleotide
ggtccccagcccaacccttgtcttaccngaa

SEQ ID NO: 90 - DNA, 31 bp, Artificial Sequence
  Description of Artificial Sequence Synthetic oligonucleotide
ggtccccagcccaacccttgtccttaccnga

SEQ ID NO: 91 - DNA, 30 bp, Artificial Sequence
  Description of Artificial Sequence Synthetic oligonucleotide
ggtccccagcccaaccttgtccttaccnga

SEQ ID NO: 92 - DNA, 31 bp, Artificial Sequence; identical to SEQ ID NO: 90
  Description of Artificial Sequence Synthetic oligonucleotide

SEQ ID NO: 93 - DNA, 29 bp, Artificial Sequence
  Description of Artificial Sequence Synthetic oligonucleotide
ggtccccagccaacccttgtccttaccng

SEQ ID NO: 94 - DNA, 79 bp, Artificial Sequence
  Description of Artificial Sequence Synthetic oligonucleotide
cagccccccagccccccagccctccaggtccccagcccaacccttgtccttaccagaacgttgttttcaggaagtctga

SEQ ID NO: 95 - DNA, 95 bp, Artificial Sequence
  Description of Artificial Sequence Synthetic oligonucleotide
cagccccccagccccccagccctccaggtccccagccctccaggtccccagcccaacccttgtccttaccagaacgttgttttcaggaagtctga

(19) United States
(12) Patent Application Publication
(10) Pub. No.: US 2010/0063742 A1
(43) Pub. Date: Mar. 11, 2010

(54) MULTI-SCALE SHORT READ ASSEMBLY

(76) Inventors: Christopher E. Hart, Cambridge, MA (US); Eldar Giladi, Arlington, MA (US); Doron Lipson, Brookline, MA (US)

Correspondence Address: BROWN RUDNICK LLP, ONE FINANCIAL CENTER, BOSTON, MA, 02111, US

(21) Appl. No.: 12/208,150

(22) Filed: Sep. 10, 2008

(51) Int. Cl. G06F 19/00

(52) U.S. Cl. 702/19; 702/181

(57) ABSTRACT

The invention generally provides methods for analyzing and constructing nucleic acid sequences and more specifically for assembling a collection of short read nucleic acid sequences to construct longer nucleic acid sequences.

### TECHNICAL FIELD OF THE INVENTION

The invention generally relates to nucleic acid sequence analysis and more specifically to the assembling of nucleic acid sequence information from a collection of short read nucleic acid subsequences.

### BACKGROUND INFORMATION

Recent advances in sequencing technology have made possible the rapid, high-throughput and cost-effective sequencing of genomic samples. In particular, next-generation sequencing technologies have resulted in increased accuracy and a significant increase in information content. See, e.g., U.S. Pat. No. 7,282,337; U.S. Pat. No. 7,279,563; U.S. Pat. No. 7,226,720; U.S. Pat. No. 7,220,549; U.S. Pat. No. 7,169,560; U.S. Pat. No. 6,818,395; U.S. Pat. No. 6,911,345; US Pub. Nos. 2006/0252077; 2007/0070349; and 2007-0070349. These automated methods and apparatus provide for high speed and high throughput analysis of long polynucleotide sequences with simplicity, flexibility and lower cost. See, e.g., www.helicosbio.com/, particularly information on HeliScope™ Sequencer.

The most promising next-generation sequencing technologies are based upon either sequencing-by-synthesis, which utilizes the natural ability of a polymerase enzyme to incorporate a nucleotide into a primer strand in a template-dependent manner, or sequencing-by-ligation, which utilizes the natural ability of a ligase enzyme to join two fragments when correctly aligned in a template-dependent manner. Single molecule sequencing technologies provide the additional benefit of allowing detection of single nucleotide incorporation in an individual surface-bound duplex. The output of these technologies is millions of short reads, generally 15 to 100 bases in length.

One of the challenges for all next-generation sequencing technologies is to find data processing methods that allow improved sequence detection and reduced error rate.

### SUMMARY OF THE INVENTION

The invention is based, in part, on the unexpected discovery that multiple short subsequences can be efficiently assembled to obtain the sequence information of a longer target nucleic acid sequence from which the short sequences (or short reads) are segments. The present invention provides methods for improving the processing of sequencing data to infer the sequence of a nucleic acid molecule that is much longer than the effective read length.

A major advantage afforded by next generation sequencing technologies is high throughput production of sequence data. However, next-generation technologies generally produce shorter sequence read lengths, e.g., less than about 100 bases in length, compared to conventional sequencing methodologies, e.g., greater than about 500 to about 1000 bases in length. The present invention provides methods for leveraging the large number of short sequence reads generated by high-throughput next generation sequencing technologies to produce longer and more accurate consensus contig reads.

Assembling short DNA or RNA sequences into longer, more accurate consensus sequences is a major challenge facing current sequencing technologies. Methods for constructing these longer consensus sequences are provided herein. These methods rely on the construction of a multi-length sequence index, statistical probability value, that can be conceptualized as a de Bruijn graph in which sequence subsequences of length (n) to (m) and the nodes in the graph are connected to each other through subsequences that are of length (n+1) to (m+1). See FIGS. 1-3. Each edge is also given a weight depending on the number of times that subsequence was observed in a sequencing experiment. Also, the invention may be used to identify sequence variants in either single or pooled samples from one or more subjects (for example, patients or healthy individuals in need of genetic analysis and information).

In one aspect, the invention is generally related to a method for constructing a target nucleic acid sequence. The method includes: a) obtaining the sequence information of a plurality of subsequences of the target nucleic acid sequence, wherein the plurality of subsequences are segments of and together form at least substantially the complete sequence of the target nucleic acid; b) selecting an initial subsequence from the plurality of subsequences and an end base thereof and analyzing the sequence information of the plurality of subsequences to obtain a statistical probability value for the base position next to the selected end base of the initial subsequence; c) analyzing the sequence information of the plurality of subsequences to obtain a statistical probability value for the base position next to the analyzed base position in b); and d) continue to repeat c) for the next positions to construct substantially the full sequence of the target nucleic acid.

In some preferred embodiments, in steps b)-d) analyzing the sequence information of the plurality of subsequences to obtain a statistical probability value for the next base position is through a multi-scale de Bruijn graph construct. The de Bruijn graph process may utilize a single weighted matrix and/or a multiple weighted matrix. In some preferred embodiments, the subsequences are sequences having 150 or fewer base pairs, 100 or fewer base pairs, or 50 or fewer base pairs. In some preferred embodiments, the subsequences are sequences having 10 or more base pairs. In some embodiments, the target nucleic acid sequence(s) are 1,000 base pairs or longer.

In another aspect, the invention generally relates to a method for assembling the sequence of a target nucleic acid having known subsequences. The method includes: a) selecting an initial subsequence from the known subsequences and an end base thereof and analyzing the sequence information of the known subsequences to obtain a statistical probability value for the base position next to the selected end base of the initial subsequence; b) analyzing the sequence information of the known subsequences to obtain a statistical probability value for the base position next to the analyzed base position in a); and c) continue to repeat b) for the next base positions to construct the full sequence of the target nucleic acid.

In some preferred embodiments, in steps b)-c) analyzing the sequence information of the plurality of subsequences to obtain a statistical probability value for the next base position is conducted through a multi-scale de Bruijn graph construct. The de Bruijn graph process may utilize a single weighted matrix and/or a multiple weighted matrix.

In yet another aspect, the invention generally relates to a method for sequencing a target nucleic acid. The method includes: a) sequencing a plurality of subsequences of the target nucleic acid, wherein the plurality of subsequences are segments of and together form the complete sequence of the target nucleic acid sequence; and b) assembling the subsequences via a de Bruijn graph process.

The foregoing aspects and embodiments of the invention may be more fully understood by reference to the following figures, detailed description and claims.

### BRIEF DESCRIPTION OF THE DRAWINGS

The invention may be further understood from the following figures in which:

FIG. 1 is an illustrative description of an exemplary embodiment of the invention.

FIG. 2 is an illustrative description of an exemplary embodiment of the invention.

FIG. 3 is an illustrative description of one embodiment of the de Bruijn graph approach.

### DETAILED DESCRIPTION OF THE INVENTION

In general, the invention relates to methods for obtaining sequence information from a plurality of short subsequences (short reads obtained from sequencing runs). Many high-throughput sequencing technologies produce sequence read lengths that are much smaller than the genomic region of interest. For example, read lengths in many of these technologies are between about 15 base pairs and about 100 base pairs on average.

Methods described herein allow the assembly of short reads into a longer assembled sequence. In one embodiment, these methods may employ the de Bruijn graph approach to assemble short read sequence data into longer sequences. See, e.g., de Bruijn, N. G. (1946) “A Combinatorial Problem” Koninklijke Nederlandse Akademie v. Wetenschappen 49: 758-764; Flye Sainte-Marie, C. (1894) “Question 48” L'Intermédiaire Math. 1: 107-110; Good, I. J. (1946) “Normal Recurring Decimals” Journal of the London Mathematical Society 21 (3): 167-169; Zhang, et al., (1987) “On the de Bruijn-Good Graphs” Acta Math. Sinica 30 (2): 195-205.

In combinatorial mathematics, a k-ary De Bruijn sequence B(k, n) of order n is a cyclic sequence of a given alphabet A with size k for which every possible subsequence of length n in A appears as a sequence of consecutive characters exactly once. Such a sequence has the following properties:

Each B(k, n) has length kⁿ

There are _{k!}k⁽ⁿ⁻¹⁾/kⁿ distinct de Bruijn sequences B(k, n).

For example, taking A={0, 1}, there are two distinct B(2, 3): 00010111 and 11101000, one being the reverse of the other. Two of the 2048 possible B(2, 5) in the same alphabetare0000010001100101001110101101111l and 0000101001000111110111001101011.

The de Bruijn sequences can be constructed by taking a Hamiltonian path of an n-dimensional de Bruijn graph over k symbols (or equivalently, a Eulerian cycle of a (n−1)-dimensional de Bruijn graph), or via finite fields. Every four-digit sequence occurs exactly once if one traverses every edge exactly once and returns to one's starting point.

Each edge in this 3-dimensional de Bruijn graph corresponds to a sequence of four digits: the three digits that label the vertex that the edge is leaving followed by the one that labels the edge. If one traverses the edge labeled 1 from 000, one arrives at 001, thereby indicating the presence of the subsequence 0001 in the de Bruijn sequence. To traverse each edge exactly once is to use each of the 16 four-digit sequences exactly once.

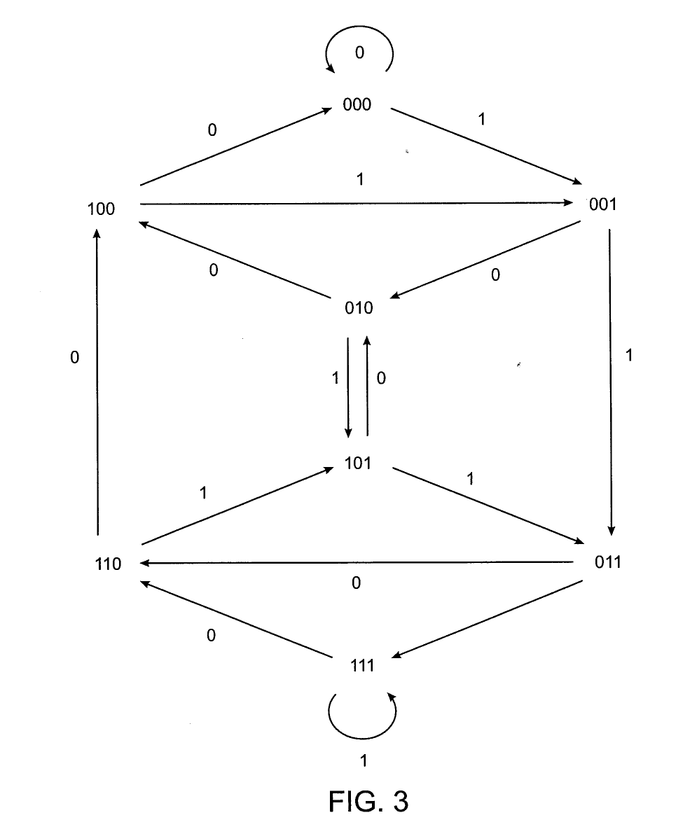

For example, following the Eulerian path:
000, 000, 001, 011, 111, 111, 110, 101, 011, 110, 100,001,010, 101,010, 100,000.
   This corresponds to the following de Bruijn sequence:
0000111101100101
   The eight vertices appear in the sequence in the following way:
{0 0 0} 0 1 1 1 1 0 1 1 0 0 1 0 1
0 {0 0 0} 1 1 1 1 0 1 1 0 0 1 0 1
0 0 {0 0 1} 1 1 1 0 1 1 0 0 1 0 1
0 0 0 {0 1 1} 1 1 0 1 1 0 0 1 0 1
0 0 0 0 {1 1 1} 1 0 1 1 0 0 1 0 1
0 0 0 0 1 {1 1 1} 0 1 1 0 0 1 0 1
0 0 0 0 1 1 {1 1 0} 1 1 0 0 1 0 1
0 0 0 0 1 1 1 {1 0 1} 1 0 0 1 0 1
0 0 0 0 1 1 1 1 {0 1 1} 0 0 1 0 1
0 0 0 0 1 1 1 1 0 {1 1 0} 0 1 0 1
0 0 0 0 1 1 1 1 0 1 {1 0 0} 1 0 1
0 0 0 0 1 1 1 1 0 1 1 {0 0 1} 0 1
0 0 0 0 1 1 1 1 0 1 1 0 {0 1 0} 1
0 0 0 0 1 1 1 1 0 1 1 0 0 {1 0 1}
. . . 0} 0 0 0 1 1 1 1 0 1 1 0 0 1 {0 1 . . .
. . . 0 0} 0 0 1 1 1 1 0 1 1 0 0 1 0 {1 . . .
   . . . and then the sequence returns to the starting point. Each of the eight 3-digit sequences (corresponding to the eight vertices) appears exactly twice, and each of the sixteen 4-digit sequences (corresponding to the 16 edges) appears exactly once. See, FIG. 3, http://en.wikipedia.org/wiki/De_Bruijn_sequence. All reads are broken down into subsequences of defined length. These subsequences represent nodes in the graph. The nodes are connected by weighted edges that are derived from subsequences that are exactly 1 base pair longer than the length of the substring representing the node. The edge weights, in previous methods are typically derived by counting the number of times the substring is observed in a sequencing dataset.

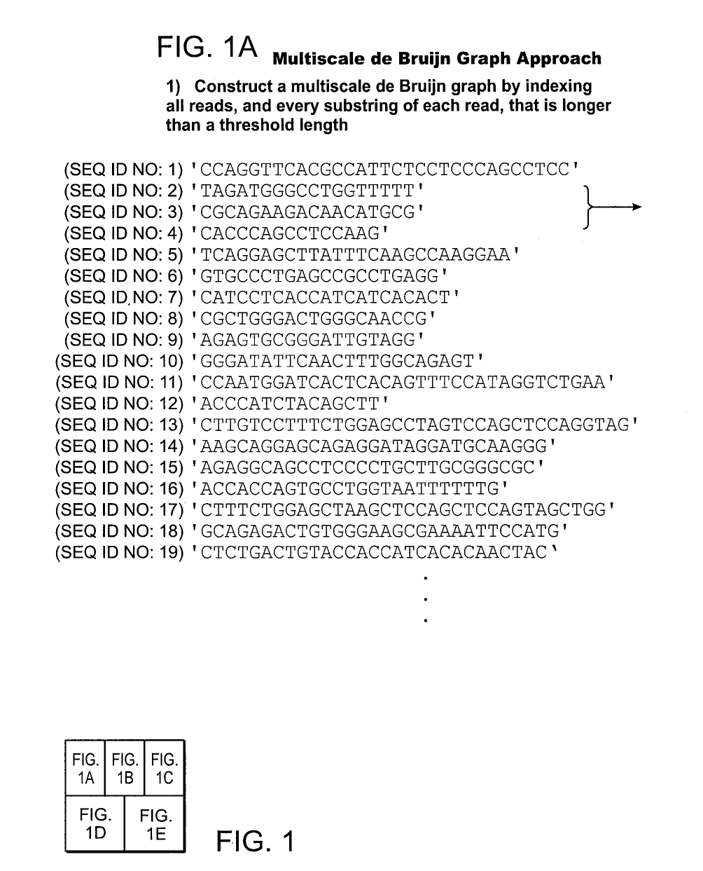

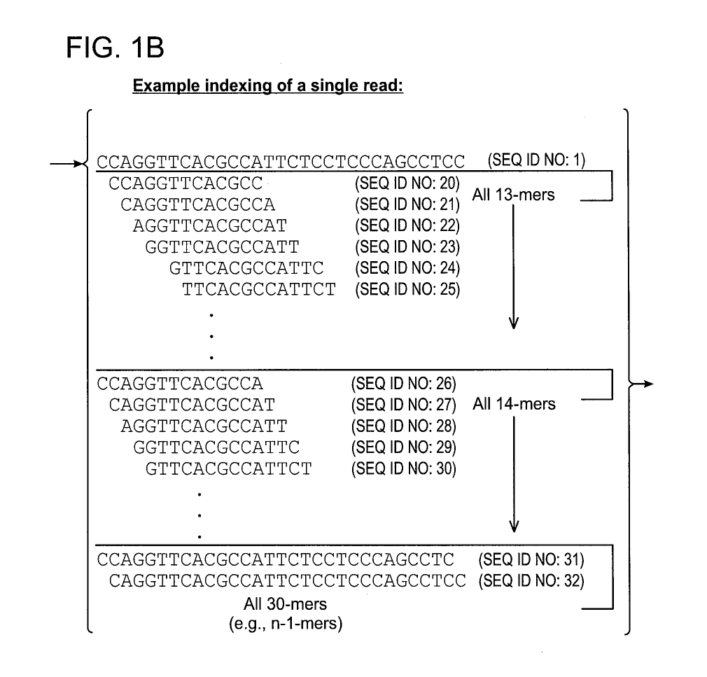

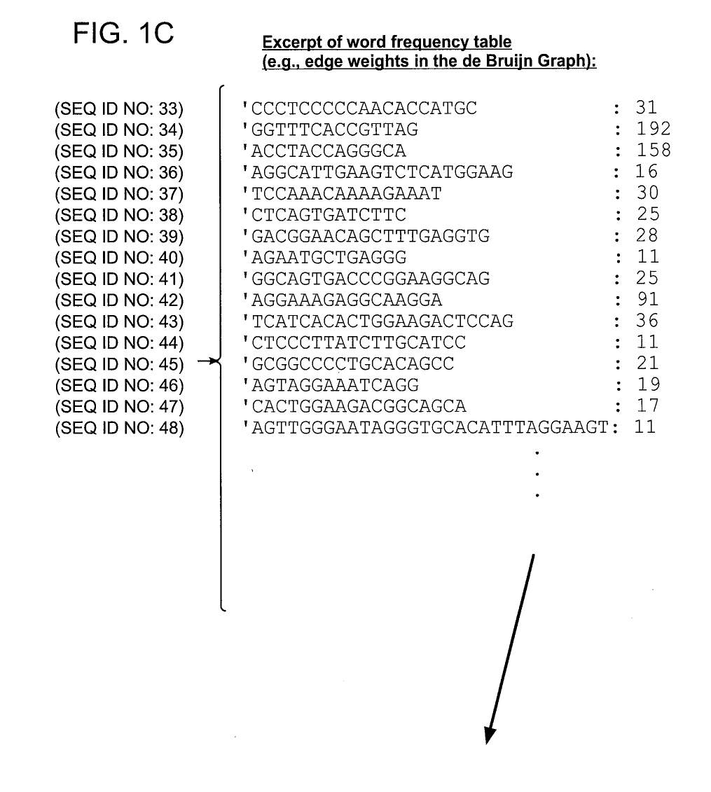

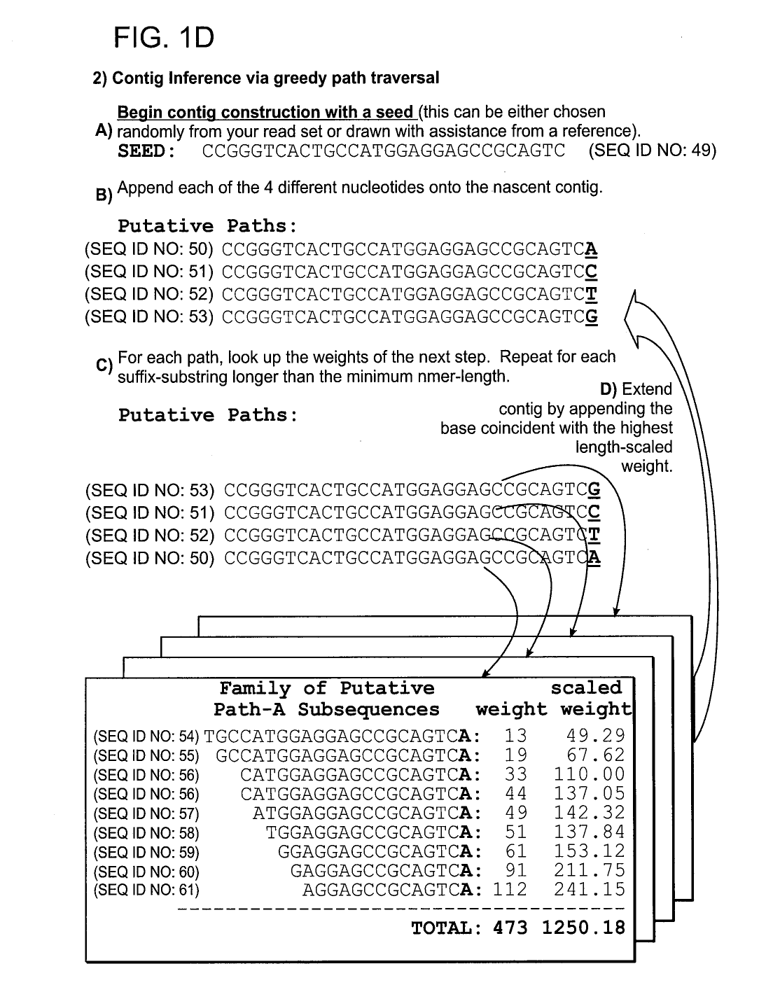

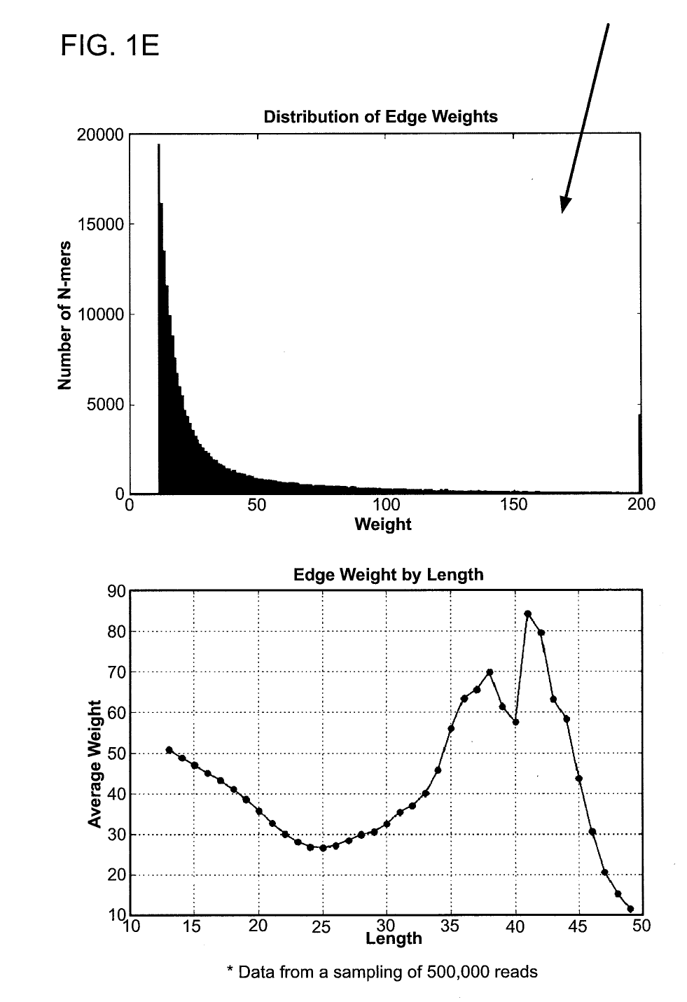

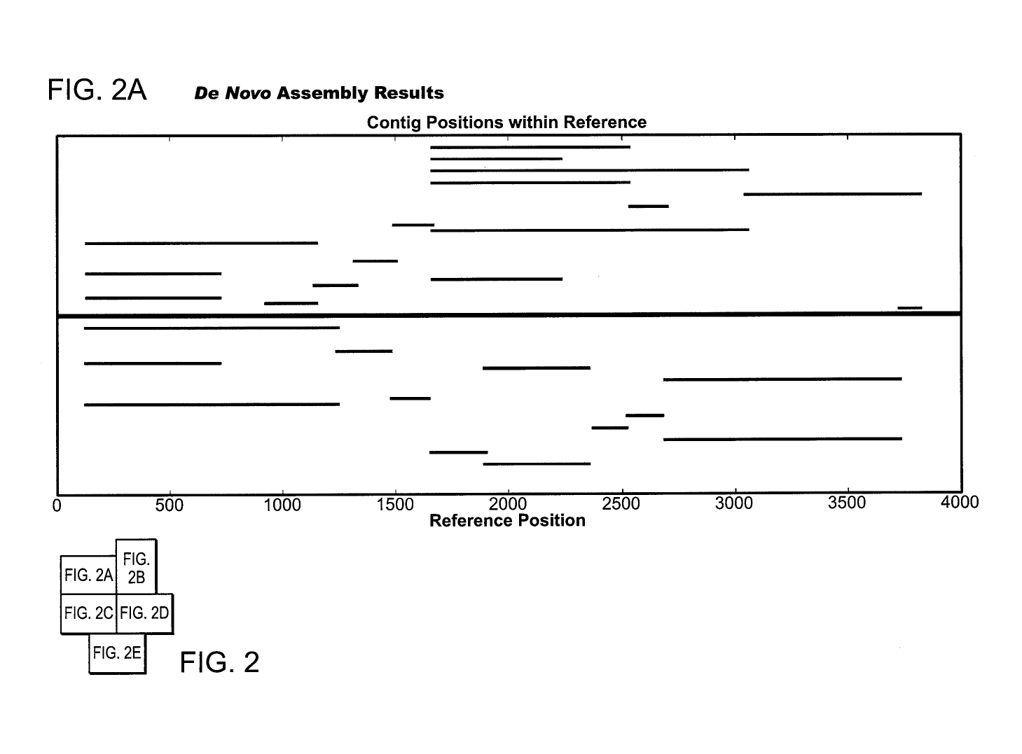

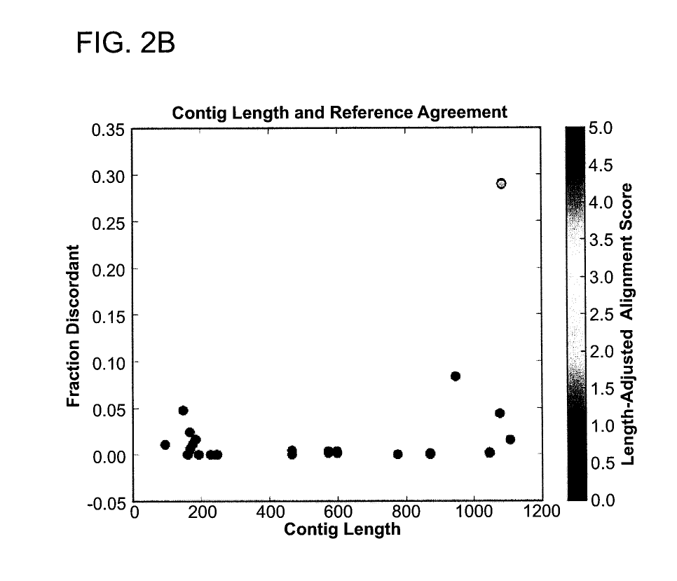

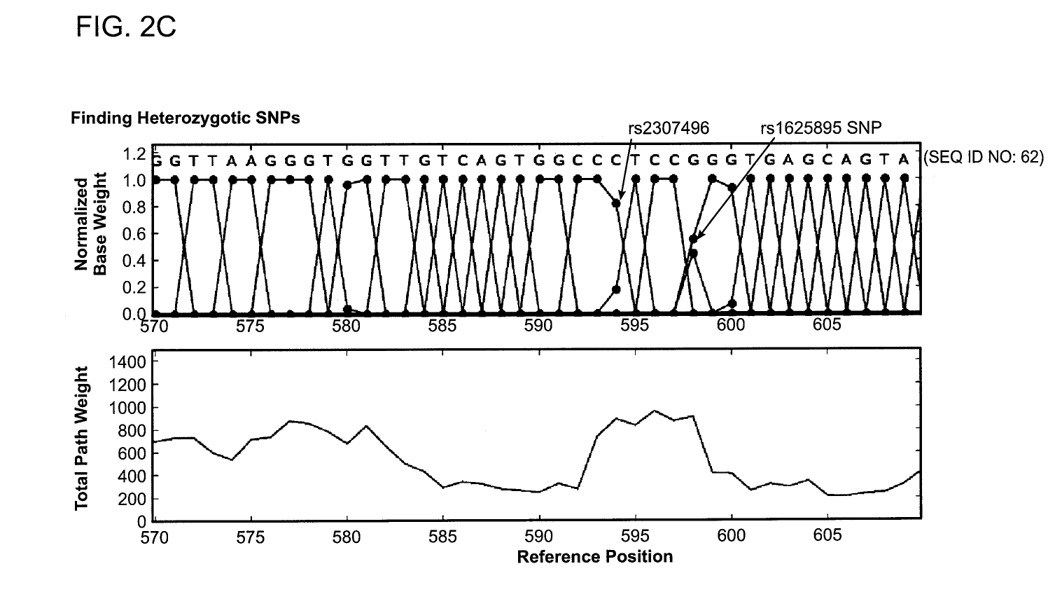

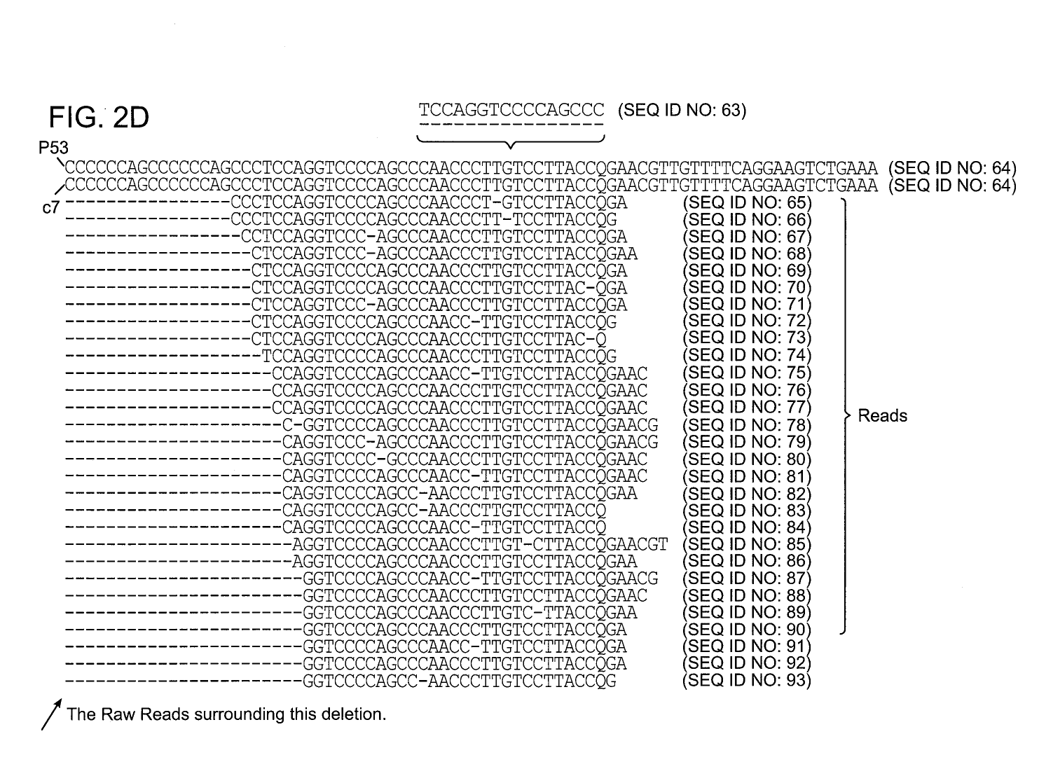

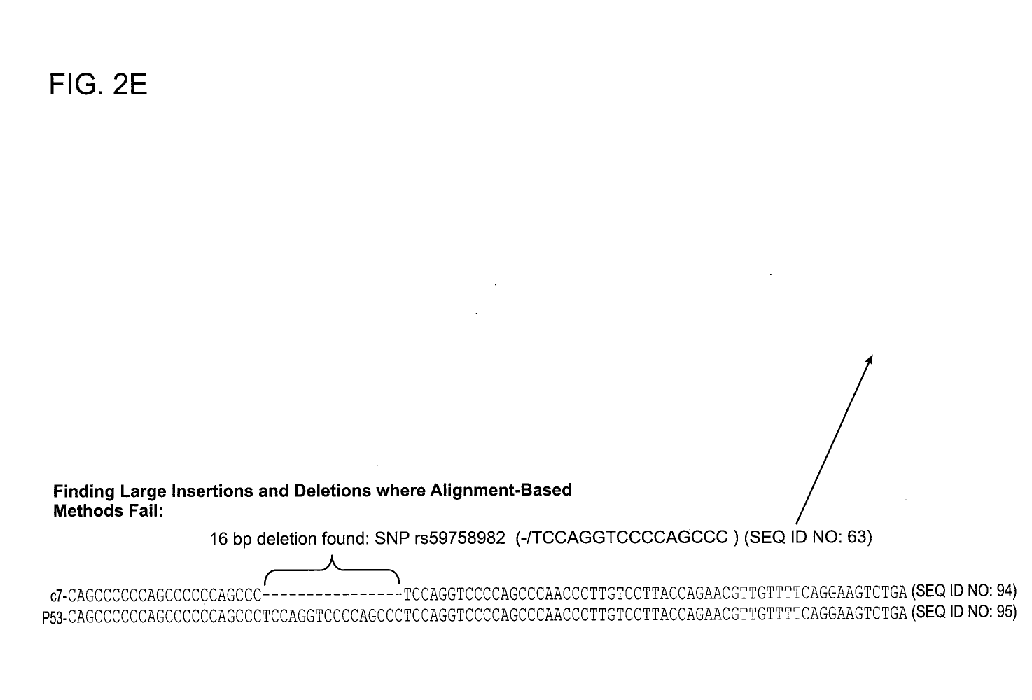

The present invention may employ nodes and edges of varying lengths. FIG. 1 is a graphical description of the algorithm for both constructing a multi-scale de Bruijn graph and generating a consensus sequence from that graph. FIG. 2 shows one example of the output of the invention and identification of known SNPs (Single Nucleotide Polymorphisms) and an In/Del found in the sample DNA.

Often samples that are subjected to DNA or RNA sequencing are comprised of many different samples. The multi-scale de Bruijn graph approach can also be used to identify sequence contexts that are multiplicatively present. For example, when constructing a consensus sequence, all possible paths from each node are followed and the resulting sequences are saved. The point at which these paths all converge represents sequence variations present within the sequenced sample. Further, the abundance of each of these variants may be correlated with the cumulative weight of each of the paths.

In one aspect, the invention is generally related to a method for constructing a target nucleic acid sequence. The method includes: a) obtaining the sequence information of a plurality of subsequences of the target nucleic acid sequence, wherein the plurality of subsequences are segments of and together form at least substantially the complete sequence of the target nucleic acid; b) selecting an initial subsequence from the plurality of subsequences and an end base thereof and analyzing the sequence information of the plurality of subsequences to obtain a statistical probability value for the base position next to the selected end base of the initial subsequence; c) analyzing the sequence information of the plurality of subsequences to obtain a statistical probability value for the base position next to the analyzed base position in b); and d) continue to repeat c) for the next positions to construct the full sequence of the target nucleic acid.

In some preferred embodiments, in steps b)-d) analyzing the sequence information of the plurality of subsequences to obtain a statistical probability value for the next base position is through a multi-scale de Bruijn graph construct. The de Bruijn graph process may utilize a single weighted matrix and/or a multiple weighted matrix.

In some preferred embodiments, the sequence information for the plurality of subsequence is obtained using a sequencing-by-synthesis process, such as a single molecule sequencing-by-synthesis process.

In some preferred embodiments, the sequence information for the plurality of subsequence is obtained using a sequencing-by-ligation process.

In some embodiments, the method of this invention is used to construct a second target nucleic acid, e.g., simultaneously or sequentially, or a third or more target nucleic acid.

The target nucleic sequence(s) may originate from a sample obtained from a single subject or from more than one subject.

In some preferred embodiments, the subsequences are sequences having 50 or fewer base pairs, 35 or fewer base pairs, 25 or fewer base pairs, or 20 or fewer base pairs. In some preferred embodiments, the subsequences are sequences having 10 or more base pairs, 15 or more base pairs, 20 or more base pairs, or 25 or more base pairs.

In some embodiments, the target nucleic acid sequence(s) are 250 base pairs or longer, 500 base pairs or longer, 1,000 base pairs or longer, 5,000 base pairs or longer, 10,000 base pairs or longer, or 50,000 base pairs or longer.

In another aspect, the invention generally relates to a method for assembling the sequence of a target nucleic acid having known subsequences. The method includes: a) selecting an initial subsequence from the known subsequences and an end base thereof and analyzing the sequence information of the known subsequences to obtain a statistical probability value for the base position next to the selected end base of the initial subsequence; b) analyzing the sequence information of the known subsequences to obtain a statistical probability value for the base position next to the base position in a); and c) continue to repeat b) for the next base positions to construct the full sequence of the target nucleic acid.

In some preferred embodiments, in steps b)-c) analyzing the sequence information of the plurality of subsequences to obtain a statistical probability value for the next base position is through a multi-scale de Bruijn graph construct. The de Bruijn graph process may utilize a single weighted matrix and/or a multiple weighted matrix.

In yet another aspect, A method for sequencing a target nucleic acid. The method includes: a) sequencing a plurality of subsequences of the target nucleic acid, wherein the plurality of subsequences are segments of and together form the complete sequence of the target nucleic acid sequence; and b) assembling the subsequences via a de Bruijn graph process.

### Incorporation by Reference

References and citations to other documents, such as patents, patent applications, patent publications, journals, books, papers, web contents, have been made throughout this disclosure. All such documents are hereby incorporated herein by reference in their entirety for all purposes.

### Equivalents

The representative examples which follow are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples which follow and the references to the scientific and patent literature cited herein. The following examples contain important additional information, exemplification and guidance which can be adapted to the practice of this invention in its various embodiments and equivalents thereof.

### EXAMPLES

Examples of certain embodiments of the invention may be found in FIGS. 1-3 herein.

### Single Molecule Sequencing

Epoxide-coated glass slides are prepared for oligo attachment. Epoxide-functionalized 40 mm diameter #1.5 glass cover slips (slides) are obtained from Erie Scientific (Salem, N.H.). The slides are preconditioned by soaking in 3×SSC for 15 minutes at 37° C. Next, a 500-pM aliquot of 5′ aminated capture oligonucleotide (oligo dT(50)) is incubated with each slide for 30 minutes at room temperature in a volume of 80 ml. The slides are then treated with phosphate (1 M) for 4 hours at room temperature in order to passivate the surface. Slides are then stored in 20 mM Tris, 100 mM NaCl, 0.001% Triton® X-100, pH 8.0 at 4° C. until they are used for sequencing.

For the illustration of the sequencing process, see, e.g., U.S. patent application Ser. Nos. 12/043,033 (Xie et al. filed Mar. 5, 2008) and 12/113,501 (Xie et al. filed May 1, 2008) (e.g., FIGS. 1A and 1B). For sequencing, the slide is placed in a modified FCS2 flow cell (Bioptechs, Butler, Pa.) using a 50-μm thick gasket. The flow cell is placed on a movable stage that is part of a high-efficiency fluorescence imaging system built based on a Nikon TE-2000 inverted microscope equipped with a total internal reflection (TIR) objective. The slide is then rinsed with HEPES buffer with 100 mM NaCl and equilibrated to a temperature of 50° C. The nucleic acid to be sequenced is sheared to approximately 200-500 bases (Covaris), polyA tailed (50-70 ave. number dA's) using dATP and terminal transferase (NEB), 3′end labeled with Cy3-ddUTP (PerkinElmer), and then diluted in 3×SSC to a final concentration of approximately 200 pM. A 100-μl aliquot is placed in the flow cell and incubated on the slide for 15 minutes. After incubation, the temperature of the flow cell is then reduced to 37° C. and the flow cell is rinsed with 1×SSC/HEPES/0.1% SDS followed by HEPES/150 mM NaCl. A passive vacuum apparatus is used to pull fluid across the flow cell. The resulting slide contains the primer template duplex randomly bound to the glass surface. Since the polyA/oligoT sequences are able to slide, the primer templates are filled and locked by firstly incubating the surface with Klenow exo+, TTP, in reaction buffer (NEB), washing thoroughly with HEPES/NaCl, and then incubating with Klenow exo+, dATP/dCTP/dGTP, in reaction buffer (NEB). The slide is washed thoroughly again using the HEPES/NaCl to remove all traces of the dNTPs before initiating the actual sequencing by synthesis process. The temperature of the flow cell is maintained at 37° C. for sequencing and the objective is brought into contact with the flow cell.

Further, Virtual Terminator™ nucleotide analogs of cytosine triphosphate, guanidine triphosphate, adenine triphosphate, and uracil triphosphate, each having a cleavable cyanine-5 label (at the 7-deaza position for ATP and GTP and at the C5 position for CTP and UTP, see, e.g., U.S. patent application Ser. Nos. 11/803,339 (Siddiqi et al. filed May 14, 2007) and 11/603,945 (Siddiqi et al. filed Nov. 22, 2006), are stored separately in the buffer containing 20 mM Tris-HCl, pH 8.8, 50 μM MnSO₄, 10 mM (NH₄)₂SO₄, 10 mM HCl, and 0.1% Triton X-100, and 50 U Kienow exo-polymerase (NEB).

Sequencing proceeds as follows. First, initial imaging is used to determine the positions of duplex on the epoxide surface. The Cy3 label attached to the nucleic acid template fragments is imaged by excitation using a laser tuned to 532 nm radiation (Verdi V-2 Laser, Coherent, Santa Clara, Calif.) in order to establish duplex position. For each slide only single fluorescent molecules that are imaged in this step are counted. Imaging of incorporated nucleotides as described below is accomplished by excitation of a cyanine-5 dye using a 635-nm radiation laser (Coherent). 100 nM Cy5-dCTP is placed into the flow cell and exposed to the slide for 2 minutes. After incubation, the slide is rinsed in 1×SSC/15 mM HEPES/0.1% SDS/pH 7.0 (“SSC/HEPES/SDS”) (15 times in 60 μl volumes each, followed by 150 mM HEPES/150 mM NaCl/pH 7.0 (“HEPES/NaCl”) (10 times at 60 μl volumes). An oxygen scavenger containing 30% acetonitrile and scavenger buffer (134 μl 150 mM HEPES/100 mMNaCl, 24 μl 100 mM Trolox in 150 mM MES, pH 6.1, 10 μl 100 mM DABCO in 150 mM MES, pH 6.1, 8 μl 2M glucose, 20 μl 50 mM Nal, and 4 μl glucose oxidase (USB) is next added. The slide is then imaged (100 frames) for 2 seconds using an Inova 301K laser (Coherent) at 647 nm, followed by green imaging with a Verdi V-2 laser (Coherent) at 532 nm for 2 seconds to confirm duplex position. The positions having detectable fluorescence are recorded. After imaging, the flow cell is rinsed 5 times each with SSC/HEPES/SDS (60 μl) and HEPES/NaCl (60 μl). Next, the cyanine-5 label is cleaved off incorporated dCTP by introduction into the flow cell of 50 mM TCEP/250mM Tris, pH 7.6/100 mM NaCl for 5 minutes, after which the flow cell is rinsed 5 times each with SSC/HEPES/SDS (60 μl) and HEPES/NaCl (60 μl). The remaining nucleotide is capped with 50 mM iodoacetamide/100 mM Tris, pH 9.0/100 mM NaCl for 5 minutes followed by rinsing 5 times each with SSC/HEPES/SDS (60 μl) and HEPES/NaCl (60 μl). The scavenger is applied again in the manner described above, and the slide is again imaged to determine the effectiveness of the cleave/cap steps and to identify non-incorporated fluorescent objects.

The procedure described above is then conducted 100 nM Cy5-dATP, followed by 100 nM Cy5-dGTP, and finally 100 nM Cy5-dUTP. Uridine may be used instead of Thymidine due to the fact that the Cy5 label is incorporated at the position normally occupied by the methyl group in Thymidine triphosphate, thus turning the dTTP into dUTP. The procedure (expose to nucleotide, polymerase, rinse, scavenger, image, rinse, cleave, rinse, cap, rinse, scavenger, final image) is repeated for a total of 80-120 cycles.

Once the desired number of cycles is completed, the image stack data (i.e., the single-molecule sequences obtained from the various surface-bound duplexes) are aligned to produce the individual sequence reads. The individual single molecule sequence read lengths obtained range from 2 to 50+ consecutive nucleotides. Only the individual single molecule sequence read lengths above some predetermined cut-off depending upon the nature of the sample, e.g. greater than 20 and above, are analyzed using the method of the invention.

What is claimed:

1. A method for constructing a target nucleic acid sequence, comprising:
a) obtaining a plurality of subsequences of a target nucleic acid, wherein the plurality of subsequences are segments of and together form substantially a complete sequence of the target nucleic acid;
b) selecting an initial subsequence from the plurality of subsequences and an end base thereof and analyzing the sequence information of the plurality of subsequences to obtain a statistical probability value for the base position next to the selected end base of the initial subsequence;
c) analyzing the sequence information of the plurality of subsequences to obtain a statistical probability value for the base position next to the analyzed base position in b); and
d) repeating step c) for the subsequent end positions to construct substantially a full sequence of the target nucleic acid.

2. The method of claim 1, wherein in said analyzing step comprises constructing a multi-scale de Bruijn graph.

3. The method of claim 2, wherein the de Bruijn graph utilizes a single weighted matrix.

4. The method of claim 2, wherein the de Bruijn graph utilizes a multiple weighted matrix.

5. The method of claim 1, wherein the sequence information for the plurality of subsequence is obtained using a sequencing-by-synthesis process.

6. The method of claim 5, wherein the sequencing-by-synthesis process is a single molecule sequencing-by-synthesis process.

7. The method of claim 1, wherein the sequence information for the plurality of subsequence is obtained using a sequencing-by-ligation process.

8. The method of claim 1, further comprising constructing a second target nucleic acid.

9. The method of claim 8, further comprising constructing a third or more target nucleic acid.

10. The method of claim 1, wherein the target nucleic sequence is from a sample obtained from a single subject.

11. The method of claim 1, wherein the target nucleic sequences are from a sample obtained from a single subject.

12. The method of claim 1, wherein the target nucleic sequences are from samples obtained from more than one subject.

13. The method of claim 1, wherein the subsequences are sequences having 35 or fewer base pairs.

14. The method of claim 1, wherein the target nucleic acid sequence is 1,000 base pairs or longer.

15. A method for assembling the sequence of a target nucleic acid having known subsequences, comprising:
a) selecting an initial subsequence from known subsequences and an end base thereof and analyzing the sequence information of the known subsequences to obtain a statistical probability value for the base position next to the selected end base of the initial subsequence;
b) analyzing the sequence information of the known subsequences to obtain a statistical probability value for the base position next to the base position in a); and
c) repeating step b) for the next base positions to construct the full sequence of the target nucleic acid.

16. The method of claim 15, wherein b)-c) utilize a single-weighted matrix process.

17. The method of claim 15, wherein b)-c) utilize a multiple-weighted matrix process.

18. The method of claim 15, wherein the subsequences are sequences having 35 or fewer base pairs.

19. The method of claim 15, wherein the target nucleic acid is 1,000 base pairs or longer.

20. The method of claim 15, further comprising assembling the sequence of a second target nucleic acid.

21. The method of claim 20, further comprising constructing a third or more target nucleic acid.

22. A method for sequencing a target nucleic acid, comprising:
a) sequencing a plurality of subsequences of a target nucleic acid, wherein the plurality of subsequences are segments of and together form a substantially complete sequence of the target nucleic acid sequence; and
b) assembling the subsequences via a de Bruijn graph process.

23. The method of claim 22, wherein b) utilizes a single-weighted matrix process.

24. The method of claim 22, wherein b) utilizes a multiple-weighted matrix process.

25. The method of claim 22, wherein the subsequences are sequences having 35 or fewer base pairs.

26. The method of claim 22, wherein the target nucleic acid is 1,000 base pairs or longer.
